(19) United States
(12) Patent Application Publication
(10) Pub. No.: US 2012/0164446 A1
(43) Pub. Date: Jun. 28, 2012

(54) PRESSURE-SENSITIVE ADHESIVE LABEL FOR HARD DISK DRIVE AND METHOD OF MANUFACTURING THE PRESSURE-SENSITIVE ADHESIVE LABEL FOR HARD DISK DRIVE

(75) Inventors: Rie NAKAHIRA, Ibaraki-shi (JP); Takahiro NONAKA, Ibaraki-shi (JP); Tsuneyuki AMANO, Ibaraki-shi (JP)

(73) Assignee: NITTO DENKO CORPORATION, Ibaraki-shi (JP)

(21) Appl. No.: 13/332,566

(22) Filed: Dec. 21, 2011

(30) Foreign Application Priority Data
Dec. 22, 2010 (JP) 2010-285576

(51) Int. Cl. B32B 7/12; B32B 37/14

(52) U.S. Cl. 428/354; 156/60

(57) ABSTRACT

A pressure-sensitive adhesive label for HDD is a pressure-sensitive adhesive label that has an information display function and can reduce the sound generated when a hard disk drive is driven by being pasted to the external surface of the case of the hard disk drive. The pressure-sensitive adhesive label for HDD includes: a substrate layer composed of a metallic foil; a rust-proof layer covering the major surface of the substrate layer; an information display layer, on the surface of which printing can be performed, provided on one of the major surfaces of a laminated body made of the substrate layer and the rust-proof layer; and a pressure-sensitive adhesive layer provided on the other major surface of the laminated body.

### BACKGROUND OF THE INVENTION

1. Field of the Invention

The present invention relates to a pressure-sensitive adhesive label for hard disk drive and a method of manufacturing the pressure-sensitive adhesive label for hard disk drive.

2. Description of the Related Art

In recent years, a demand for hard disk drive to be used in consumer products including personal computers has been drastically growing. With the growth, the silence property of a hard disk drive when driven is made to be an important property for the hard disk drive.

To deal with this, a pressure-sensitive adhesive label is disclosed in, for example, Japanese Patent Application Publication No. 2007-332293, in which the sound generated when a hard disk drive is driven is reduced by pasting the pressure-sensitive adhesive label to the surface of the case of the hard disk drive. The pressure-sensitive adhesive label is composed of: a substrate layer made of a metal sheet; a pressure-sensitive adhesive layer formed on one of the surfaces of the substrate layer; and an information-display layer formed on the other surface of the substrate layer, and the pressure-sensitive adhesive label is pasted to the external surface of the case of a hard disk drive via the pressure-sensitive adhesive layer. The pasted pressure-sensitive adhesive label attenuates the voice vibrations generated inside the hard disk drive by using the viscoelasticity of the pressure-sensitive adhesive layer and the stiffness of the substrate layer, etc., thereby allowing the sound generated when the hard disk drive is driven to be reduced. In addition, the product information, etc., of the hard disk drive can be printed on the information-display layer of the pressure-sensitive adhesive label.

In the aforementioned pressure-sensitive adhesive label to be pasted to a hard disk drive, the pressure-sensitive adhesive layer formed on one of the surfaces of the substrate layer has a relatively high water absorbability. Accordingly, there has been the possibility that: the oxidation of the metal sheet of which the substrate layer is composed is accelerated by the contacts between the moisture absorbed in the pressure-sensitive adhesive layer and the substrate layer, and as a result, the metal sheet maybe rusted (corroded). In recent years, hard disk drives have been used in diversified environments, and with this, pressure-sensitive adhesive labels for hard disk drive are also required to be able to be used in an environment in which the oxidation of metal sheets is more likely to be accelerated. For the requirement, there has been room for improvement in the conventional pressure-sensitive adhesive labels for hard disk drive in terms of satisfying the requirement of enhancing the durability of the pressure-sensitive adhesive label.

### SUMMARY OF THE INVENTION

The present invention has been made in view of these situations, and a purpose of the invention is to provide a technique in which the durability of a pressure-sensitive adhesive label for hard disk drive can be enhanced, the lo pressure-sensitive adhesive label being used for reducing the sound generated when a hard disk drive is driven.

An embodiment of the present invention is a pressure-sensitive adhesive label for hard disk drive. The pressure-sensitive adhesive label for hard disk drive has an information display function and can reduce the sound generated when a hard disk drive is driven by being pasted to the external surface of the case of the hard disk drive. The pressure-sensitive adhesive label comprises: a substrate layer composed of a metallic foil; a rust-proof layer covering at least one of the major surfaces of the substrate layer; an information display layer, on the surface of which printing can be performed, provided on one of the major surfaces of a laminated body made of the substrate layer and the rust-proof layer; and a pressure-sensitive adhesive layer provided on the other major surface of the laminated body.

According to the pressure-sensitive adhesive label for hard disk drive of this embodiment, the durability of a pressure-sensitive adhesive label for hard disk drive can be enhanced, the pressure-sensitive adhesive label being used for reducing the sound generated when a hard disk drive is driven.

In the pressure-sensitive adhesive label for hard disk drive according to the aforementioned embodiment, the rust-proof layer maybe made of a material that is more resistant to rust than the metallic foil. Also, the rust-proof layer may be a plated layer or a chemical conversion treatment layer provided on the surface of the metallic foil. Also, the metallic foil may be an iron foil and the rust-proof layer may be made of a metal selected from the group consisting of zinc, tin, nickel, and chromium.

The pressure-sensitive adhesive label for hard disk drive according to the aforementioned embodiment may further comprise a chromate film provided on the major surface of the rust-proof layer, opposite to the substrate layer. Also, the rust-proof layer may be provided at least between the substrate layer and the pressure-sensitive adhesive layer, and the pressure-sensitive adhesive label for hard disk drive may further comprise a coat layer that is provided between the rust-proof layer and the pressure-sensitive adhesive layer to enhance the adhesiveness between the two. Also, the pressure-sensitive adhesive layer may contain an acrylic polymer.

Another embodiment of the present invention is a method of manufacturing a pressure-sensitive adhesive label for hard disk drive. The method of manufacturing a pressure-sensitive adhesive label for hard disk drive is a method of manufacturing a pressure-sensitive adhesive label for hard disk drive that has an information display function and can reduce the sound generated when a hard disk drive is driven by being pasted to the external surface of the case of the hard disk drive. The method comprises: forming a laminated body made of a substrate layer and a plated layer by subjecting the substrate layer composed of a metallic foil to plate processing; forming, on one of the major surfaces of the laminated body, an information display layer, on the surface of which printing can be performed; and forming a pressure-sensitive adhesive layer on the other major surface of the laminated body.

### BRIEF DESCRIPTION OF THE DRAWINGS

Embodiments will now be described, byway of example only, with reference to the accompanying drawings, which are meant to be exemplary, not limiting, and wherein like elements are numbered alike in several figures, in which:

FIG. 1 is a schematic sectional view illustrating the configuration of a pressure-sensitive adhesive label for hard disk drive according to an embodiment; and

FIG. 2 is a schematic perspective view of a hard disk drive to which the pressure-sensitive adhesive label for hard disk drive according to the embodiment has been pasted.

### DETAILED DESCRIPTION OF THE INVENTION

Hereinafter, the present invention will be described with reference to the drawings based on the preferred embodiments of the invention. The preferred embodiments do not intend to limit the scope of the invention but exemplify the invention. All of the features and the combinations thereof described in the embodiments are not necessarily essential to the invention.

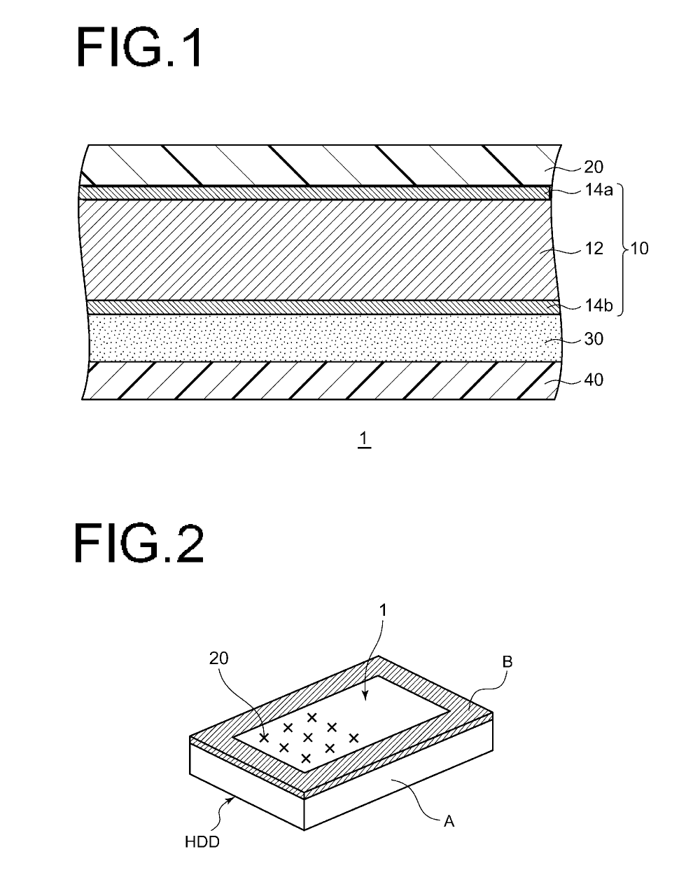

FIG. 1 is a schematic sectional view illustrating the configuration of a pressure-sensitive adhesive label for hard disk drive according to an embodiment. FIG. 2 is a schematic perspective view of a hard disk drive to which the pressure-sensitive adhesive label for hard disk drive according to the embodiment has been pasted.

As illustrated in FIG. 1, the pressure-sensitive adhesive label 1 for hard disk drive according to the embodiment comprises: a laminated body 10 made of a substrate layer 12 and rust-proof layers 14a and 14b covering the major surfaces of the substrate layer 12; an information display layer 20 provided one of the major surfaces of the laminated body 10; and a pressure-sensitive adhesive layer 30 provided on the other major surface of the laminated body 10. Hereinafter, each layer of which the pressure-sensitive adhesive label 1 for HDD is composed will be described in detail. Hereinafter, a “pressure-sensitive adhesive label for hard disk drive” will be appropriately referred to as a “pressure-sensitive adhesive label for HDD”

### [Substrate Layer]

The substrate layer 12 is a layer composed of a metallic foil. The metallic foil of which the substrate layer 12 is composed is not particularly limited, as far as the metallic foil has an effect of reducing the sound generated when a hard disk drive is driven. A metallic foil made of, for example, iron, aluminum, stainless steel, nickel, copper, or the like, can be used. Among them, an iron foil is preferred in terms of economic efficiency. The thickness of the substrate layer 12 is, for example, within a range of 10 μm to 150 μm. By making the thickness of the substrate layer 12 to be 10 μm or more, the stiffness required of the substrate layer 12 can be maintained more surely. Also, by making the thickness of the substrate layer 12 to be 150 μm or less, it can be reduced that a large space where a hard disk drive to which the pressure-sensitive adhesive label 1 for HDD has been pasted is to be installed may be needed.

### [Rust-Proof Layer]

The rust-proof layers 14a and 14 are used for preventing the metallic foil of which the substrate layer 12 is composed from being rusted. Herein, “being rusted” includes a phenomenon in which a metal other than iron is oxidized to generate a corroded product. The rust-proof layer 14a is provided between the substrate layer 12 and the information display layer 20 and the rust-proof layer 14b is provided between the substrate layer 12 and the pressure-sensitive adhesive layer 30. The rust-proof layers 14a and 14b are not particularly limited, as far as they exhibit an effect of preventing rust of a metallic foil. Each of them is, for example, a plated layer or a chemical conversion treatment layer provided on the surface of a metallic foil. Examples of the plated layer include, for example, a zinc plated layer, tin plated layer, nickel plated layer, chromium plated layer, or the like, each of which has been formed by, for example, subjecting the surface of a metallic foil to plate processing using zinc, tin, nickel, chromium, or the like. The chemical conversion treatment layer is a layer formed by subjecting the surface of a metallic foil to a chemical conversion treatment. Examples of such a chemical conversion treatment layer include, for example, a passive layer formed by passivation of the surface of a metallic foil, a layer made of a chromate film formed by subjecting the surface of a metallic foil to a chromate treatment, a layer made of a film formed by subjecting the surface of a metallic foil to a phosphate treatment, a chromic acid treatment, or a zirconium treatment, etc., and the like. Examples of the passive layer include, for example, a layer made of a metal oxide film formed by oxidation of the surface of a metallic foil, and the like. In addition, each of the rust-proof layers 14a and 14 may be a resin layer that can exert a rust prevention action to a metallic foil. Examples of such a resin layer include resin layers made of an acrylic resin, polyolefin resin, polyester resin, epoxy resin, and urethane resin, etc., and the like. Alternatively, each of the rust-proof layers 14a and 14b may be a layer formed by a method in which the surface of a metallic foil is subjected to a cure treatment, or a method selected from the group consisting of thermal spraying, sputtering, vapor deposition, hot stamp and coating, etc., each of which treats a material for forming a rust-proof layer on the surface of a metallic foil.

The rust-proof layer 14a suppresses the oxidation of the metallic foil of which the substrate layer 12 is composed by hindering a pressure-sensitive adhesive (not illustrated) having a high water absorbability, used for adhering the information display layer 20 to the laminated body 10, from being brought into contact with the substrate layer 12, the oxidation possibly being caused by the moisture contained in the adhesive. Also, the rust-proof layer 14b suppresses the oxidation of the metallic foil by hindering the pressure-sensitive adhesive layer 30 having a high water absorbability from being brought into contact with the substrate layer 12, the oxidation possibly being caused by the moisture contained in the pressure-sensitive adhesive layer 30. Thereby, the progression of the rust of the metallic foil can be delayed, and hence the durability of the pressure-sensitive adhesive label 1 for HDD can be enhanced. Also, when the substrate layer 12 is rusted and the color thereof is changed, it becomes difficult to read the information printed on the information display layer 20 due to the area in the substrate layer 12 whose color has been changed, the area being able to be visibly recognized through the information display layer 20, thereby causing the fear that the information display function of the pressure-sensitive adhesive label 1 for HDD maybe impaired. To deal with this fear, the rust-proof layers 14a and 14b hinder the progression of the rust of the substrate layer 12 in the pressure-sensitive adhesive label 1 according to the embodiment, and hence it can be reduced that the information display function of the pressure-sensitive adhesive label 1 for HDD may be decreased.

It is preferable that the rust-proof layers 14a and 14b are made of a material that is more resistant to rust than the metallic foil of which the substrate layer 12 is composed. By making the rust-proof layers 14a and 14b for preventing the rust of the substrate layer 12 to be more resistant to rust themselves, it can be suppressed that the durability of the pressure-sensitive adhesive label 1 for HDD may be decreased by the rust of the rust-proof layers 14a and 14b. Further, the color change occurring due to the rust of the rust-proof layers 14a and 14b themselves are not visibly recognized in this case, and hence it can be further reduced that the information display function of the pressure-sensitive adhesive label 1 for HDD may be decreased. Examples of the aforementioned “material that is more resistant to rust than the metallic foil” include: a metal that is more resistant to oxidization than the metal of which the metallic foil of the substrate layer 12 is composed; a metal whose corrosion can be prevented by forming an oxide film denser than the oxide film formed on the metallic foil by oxidation; a metal oxide of which the aforementioned passive layer is composed; a resin that is not rusted at all; and the like.

For example, the metallic foil of which the substrate layer 12 is composed is an iron foil, and the rust-proof layers 14a and 14b are made of a metal selected from the group consisting of zinc, tin, nickel, and chromium. Tin and nickel are metals that are more resistant to oxidization than iron of which the metallic foil is composed. Each of zinc and chromium is more resistant to rust or corrosion than iron because it forms a dense oxide film on the surface thereof.

The thickness of each of the rust-proof layers 14a and 14b is not particularly limited, but is, for example, within a range of 0.001 μm to 3 μm. By making the thickness of each of the two is to be 0.001 μm or more, the durability enhancing function, etc., of the rust-proof layers 14a and 14b can be exerted more surely. Also, by making the thickness of each of the rust-proof layers 14a and 14b to be 3 μm or less, it can be reduced that a large space where a hard disk drive to which the pressure-sensitive adhesive label 1 for HDD has been pasted is to be installed may be needed.

In the pressure-sensitive adhesive label 1 for HDD illustrated in FIG. 1, the major surfaces on both sides of the substrate later 12 are covered with the rust-proof layers 14a and 14b, respectively; however, the aforementioned effect of enhancing the durability and the effect of preventing a decrease in the information display function can be exerted when at least one of the major surfaces of the substrate layer 12 is covered with a rust-proof layer. Also, the durability can be enhanced when at least part of each major surface of the substrate layer 12 is covered with a rust-proof layer, in comparison with the case where each major surface is not covered at all, thereby allowing a decrease in the information display function to be prevented.

### [Information Display Layer]

The information display layer 20 is a layer on which printing can be performed. Various information including, for example, “Instructions for Proper Use”, “Connection Method”, and “Recognition and Identification of Names of Product and Manufacture”, etc., with respect to the hard disk drive to which the pressure-sensitive adhesive label 1 for HDD is to be pasted, are printed. Information can be printed on the information display layer 20 by using a normal printing method, such as an ink jet printing method or a thermal transfer method. A material of which the information display layer 20 is composed is not particularly limited, as far as printing can be performed thereon and the information display function of the pressure-sensitive adhesive label 1 for HDD can be exerted. Examples of the material include resin films made of, for example, polyethylene terephthalate (PET), polybutylene terephthalate (PBT), polyimide (PI), polyethylene (PE), polypropylene (PP), etc. Among them, polyethylene terephthalate is preferred in terms of economic efficiency and durability, and in particular, a white polyethylene terephthalate film layer is preferred. The thickness of the information display layer 20 is not particularly limited, but is, for example, within a range of approximately 5 to 30 μm.

### [Pressure-Sensitive Adhesive Layer]

The pressure-sensitive adhesive layer 30 is a layer for attaching the pressure-sensitive adhesive label 1 for HDD to the external surface of the case of a hard disk drive, and is composed of a pressure-sensitive adhesive. As the pressure-sensitive adhesive of which the pressure-sensitive adhesive layer 30 is composed, one or more pressure-sensitive adhesives appropriately selected from the publicly known pressure-sensitive adhesives, such as a synthetic rubber pressure-sensitive adhesive, natural rubber pressure-sensitive adhesive, acrylic pressure-sensitive adhesive, urethan pressure-sensitive adhesive, epoxy pressure-sensitive adhesive, silicone pressure-sensitive adhesive, and polyester pressure-sensitive adhesive, can be used.

It is preferable that the pressure-sensitive adhesive of which the pressure-sensitive adhesive layer 30 is composed contains an acrylic polymer, i.e., the pressure-sensitive adhesive is an acrylic pressure-sensitive adhesive in terms of durability. More specifically, a pressure-sensitive adhesive composed of a polymer (base polymer) whose major component is (meth)acrylic acid alkyl ester having 4 to 14 carbon atoms (hereinafter, appropriately referred to as “(meth)acrylic acid C₄₋₁₄ alkyl ester”) is preferred. Examples of the (meth)acrylic acid C₄₋₁₄ alkyl ester include, for example: (meth)acrylic acid butyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid heptyl, (meth)acrylic acid 2-ethylhexyl, (meth)acrylic acid octyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, (meth)acrylic acid lauryl, (meth)acrylic acid myristyl, and (meth)acrylic acid isomyristyl, etc. These (meth)acrylic acid C₄₋₁₄ alkyl esters can be used alone or in combination of two or more of them.

As the acrylic pressure-sensitive adhesive, an acrylic pressure-sensitive adhesive composed of a polymer containing, as copolymerization components, both (meth)acrylate with an alkyl group having 7 to 10 carbon atoms (hereinafter, appropriately referred to as “(meth)acrylic acid C₇₋₁₀ alkyl ester”) and acrylic acid, can be preferably used in terms of satisfying, at an excellent level, both the glass transition temperature and the adhesive property of the pressure-sensitive adhesive, which greatly contribute to the later-described damping performance of the pressure-sensitive adhesive layer 30. On the other hand, it is preferable in terms of enhancing the release property from the case of a hard disk drive that the amount of the acrylic acid is small in order to suppress the pressure-sensitive adhesive force from being increased over time.

Accordingly, from these viewpoints, an acrylic pressure-sensitive adhesive in which the ratio of (meth)acrylic acid, as a monomer component, is 10% by mass or less, for example, within a range of 0.5 to 10% by mass, and preferably 7% by mass or less, for example, within a range of 1 to 7% by mass, based on the total mass of the monomer components, is preferred among acrylic pressure-sensitive adhesives. Specifically, as the acrylic pressure-sensitive adhesive, an acrylic pressure-sensitive adhesive containing a copolymer whose monomer components are both (meth)acrylic acid in an amount, for example, within a range of 0.5 to 10% by mass, preferably within a range of 1 to 7% by mass, and (meth)acrylic acid ester in an amount, for example, within a range of 90 to 99.5% by mass, preferably within a range of 93 to 99% by mass, based on the total mass of the monomer components, can be preferably used.

The damping performance of the pressure-sensitive adhesive layer 30 are greatly affected by the glass transition temperature of the pressure-sensitive adhesive. In order to effectively exert the performance at the operating temperature of the pressure-sensitive adhesive label 1 for HDD, it is preferable that the loss coefficient of the pressure-sensitive adhesive is 0.5 or more and 5.0 or less, and preferably 0.7 or more and 5.0 or less at 20° C. It is noted that the operating temperature of the pressure-sensitive adhesive label 1 for HDD is the operating temperature of a hard disk drive, and it is usually higher than or equal to room temperature. It is preferable that the peak temperature of the loss coefficient of the pressure-sensitive adhesive is −10° C. or higher and 50° C. or lower. By making the loss coefficient of the pressure-sensitive adhesive and/or the peak temperature of the loss coefficient to be within the aforementioned ranges, the damping performance and the adhesive property of the pressure-sensitive adhesive layer 30 can be both satisfied at an excellent level.

The thickness of the pressure-sensitive adhesive layer 30 is not particularly limited, but it is preferably 10 μm or more, and more preferably within a range of 15 to 100 μm, in terms of an effect of reducing the sound generated when a hard disk drive is driven. Also, the thickness thereof is preferably 15 μm or more, and more preferably within a range of approximately 50 to 350 μm, in terms of sealing property and adhesive property.

Accordingly, the thickness of the pressure-sensitive adhesive layer 30 is preferably selected from, for example, a range of 15 to 100 μm.

### [Release Liner]

The major surface of the pressure-sensitive adhesive layer 30, opposite to the laminated body 10, is covered with a release liner 40 for protecting the pressure-sensitive adhesive layer 30. As the release liner 40, commonly-used release paper can be used. Examples of the release liner 40 include, for example: polyolefin films formed of a polyolefin resin made of polyethylene (low density polyethylene, linear low density polyethylene, etc.), polypropylene, ethylene-α-olefin copolymer (block copolymer or random copolymer) such as ethylene-propylene copolymer, and a mixture made of these; release liners composed of plastic films each having a high release property itself, such as a film made of Teflon™; and release liners in each of which a release layer is formed on one of the surfaces of each of various support bodies by using the material of the above plastic films each having a high release property. Examples of the various support bodies include, for example: plastic films, such as polyethylene terephthalate film, polyimide film, polypropylene film, polyethylene film, and polycarbonate film, and metal deposited plastic films; various kinds of paper, such as Japanese paper, foreign paper, and glassine paper; substrates formed of fiber materials such as non-woven cloth and cloth; and metallic foils, etc. The release layer formed on one of the surfaces of each of various support bodies can be formed by laminating or coating: a polyolefin film made of a polyolefin resin, such as polyethylene, polypropylene, or ethylene-α-olefin copolymer such as ethylene-propylene copolymer; a film made of Teflon™, or the like.

As the release liner 40, a release liner in which a release treatment agent layer made of a release treatment agent is formed on the surface of a release liner substrate can also be used. The release treatment agent is not particularly limited, but examples thereof include removers, such as, for example, a long chain alkyl group-containing polymer, silicone polymer (silicone remover), fluorine polymer (fluorine remover). Examples of the release liner substrate include, for example: plastic films, such as polyethylene terephthalate film, polyimide film, polypropylene film, polyethylene film, and polycarbonate film, and metal deposited plastic films; various kinds of paper, such as Japanese paper, foreign paper, and glassine paper; substrates formed of fiber materials such as non-woven cloth and cloth; and metallic foils, etc.

As the release liner 40, a release liner in which a polyethylene terephthalate film is used as a support body and a release layer is formed on one of the surfaces of the support body is preferred, in terms of punching quality and less deformation occurring due to the tension force while a pressure-sensitive adhesive label is being processed. The thickness (total thickness) of the release liner is not particularly limited, but usually within a range of approximately 30 to 200 μm. As the release liner 40, a release liner containing a small amount of a silicone component to be transferred onto the surface of a pressure-sensitive adhesive layer and further a release liner not containing a silicone remover as the remover are preferably used in order to prevent a failure generated due to the silicone component, such as a contact failure, from occurring in a precision electronic device, such as a hard disk drive.

The pressure-sensitive adhesive label 1 for HDD is manufactured, for example, as follows. The method of manufacturing the pressure-sensitive adhesive label 1 for HDD, described below, is an example of the case where the rust-proof layers 14a and 14b are plated layers. The substrate layer 12 composed of a metallic foil is first subjected to plate processing by a hot dip plating method and an electrolytic plating method, etc., to form the laminated body 10 made of the substrate layer 12 and the plated layers as the rust-proof layers 14a and 14b. Subsequently, the information display layer 20, on the surface of which printing can be performed, is formed on one of the major surfaces of the laminated body 10 by a publicly-known lamination method, such as, for example, a dry lamination method. Also, the pressure-sensitive adhesive layer 30 is formed on the other major surface of the laminated body 10 prior to, after, or simultaneously with the formation of the information display layer 20. As the method of forming the pressure-sensitive adhesive layer 30, a method of applying a pressure-sensitive adhesive to the other major surface of the laminated body 10 by a publicly-known application method, a method in which the pressure-sensitive adhesive layer 30 that has been formed by applying a pressure-sensitive adhesive to an appropriate separator, such as release paper, is transferred onto the other major surface of the laminated body 10, or the like, can be used.

When the rust-proof layers 14a and 14b are chemical conversion treatment layers, the rust-proof layers 14a and 14b can be formed by subjecting the substrate layer 12 to a publicly-known oxidation treatment or chromate treatment, etc. Alternatively, when the rust-proof layers 14a and 14b are resin layers, the rust-proof layers 14a and 14b can be formed on the substrate layer 12 by, for example, coating.

In the pressure-sensitive adhesive label 1 for HDD, the release liner 40 is released from the pressure-sensitive adhesive layer 30 when used. The pressure-sensitive adhesive label 1 for HDD, arranged such that the information display layer 20 is turned outward and the pressure-sensitive adhesive layer 30 is turned toward the case of a hard disk drive HDD, is pasted to the case by adhering the pressure-sensitive adhesive layer 30 to the surface of the case.

For example, the case of the hard disk drive HDD is composed of both a housing main body A in which a recording disk, a magnetic head, and a spindle motor, etc., (all not illustrated) are housed, and a top cover B, and the pressure-sensitive adhesive label 1 for HDD is pasted to the external surface of the top cover B, as illustrated in FIG. 2. In a state where the pressure-sensitive adhesive label 1 for HDD has been pasted to the top cover B, the vibrations of the case, occurring when the hard disk drive HDD is driven, are transmitted to the pressure-sensitive adhesive layer 30. Because the pressure-sensitive adhesive layer 30 is restrained (backed) by the substrate layer 12, the kinetic energy by the vibrations of the external surface of the case of the hard disk drive HDD, the kinetic energy being transmitted to the pressure-sensitive adhesive layer 30, is converted into thermal energy by the pressure-sensitive adhesive layer 30. As a result of the vibrations of the case of the hard disk drive HDD being absorbed in the pressure-sensitive adhesive layer 30, as stated above, the sound generated when the hard disk drive HDD is driven can be reduced.

When pasted to the external surface of the case of the hard disk drive HDD, such as the housing main body A or the top cover B, via the pressure-sensitive adhesive layer 30, the pressure-sensitive adhesive label 1 for HDD can reduce the sound generated when the hard disk drive is driven mainly by the damping performance of the pressure-sensitive adhesive layer 30. Further, the information display layer 20 is turned outward, and hence the pressure-sensitive adhesive label 1 for HDD can exert an information display function when information has been printed on the information display layer 20. The aforementioned “the sound generated when the hard disk drive is driven can be reduced” means that the sound generated when the hard disk drive HDD is drive can be reduced by 1 dB or more by pasting the pressure-sensitive adhesive label 1 for HDD according to the embodiment to the hard disk drive HDD, in comparison with the generated sound prior to the pasting.

In order to reduce the sound generated when a hard disk drive is driven, it is better that the area of a portion to which the pressure-sensitive adhesive label 1 for HDD is to be pasted is made large with respect to the external surface of the case of the hard disk drive HDD. For example, it is preferable that the pressure-sensitive adhesive label 1 for HDD is pasted to a portion, the area of which is 20% or more, and preferably within a range of 25 to 100%, based on the total area of the external surface of the top cover B of the hard disk drive HDD.

The pressure-sensitive adhesive label 1 for HDD may further comprise a chromate film provided on the major surface of each of the rust-proof layers 14a and 14b, opposite to the substrate layer 12. By forming a chromate film on the major surface of each of the rust-proof layers 14a and 14b, the corrosion resistance of each of the rust-proof layers 14a and 14b can be enhanced. As a result of that, the durability of the pressure-sensitive adhesive label 1 for HDD can be further enhanced, and a decrease in the information display function can be prevented more surely. The thickness of the chromate film is not particularly limited, but is, for example, appropriately 0.005 μm. If the thickness of the chromate film is too small, the effect of enhancing the corrosion resistance of each of the rust-proof layers 14a and 14b is decreased, and if the thickness thereof is too large, the thickness of the pressure-sensitive adhesive label 1 for HDD becomes large.

The pressure-sensitive adhesive label 1 for HDD may further comprise a coat layer that is provided between the rust-proof layer 14b and the pressure-sensitive adhesive layer 30 to enhance the adhesiveness between the two. The coat layer is a layer for enhancing the anchoring property of the pressure-sensitive adhesive layer 30 with respect to the rust-proof layer 14b via itself. By providing the coated layer, the adhesiveness between the rust-proof layer 14b and the pressure-sensitive adhesive layer 30 can be enhanced without enhancing the pressure-sensitive adhesive force of the pressure-sensitive adhesive layer 30. Further, with this, a phenomenon in which a pressure-sensitive adhesive component remains on the hard disk drive side when the pressure-sensitive adhesive label 1 for HDD, pasted to the external surface of the case of the hard disk drive, is released therefrom, so-called adhesive deposit can be suppressed.

One or more coat layer agents can be used as coat layer agents of which the coat layer is composed, the one or more coat layer agents being appropriately selected from publicly-known coat layer agents, such as, for example, an acrylic coat layer agent, polyester coat layer agent, rubber coat layer agent, isocyanate coat layer agent, and epoxy coat layer agent, etc. The coat layer agent can be appropriately selected in accordance with the pressure-sensitive adhesive of which the pressure-sensitive adhesive layer 30 is composed and the material of which the rust-proof layer 14b is composed, etc. For example, when the pressure-sensitive adhesive layer 30 is composed of an acrylic pressure-sensitive adhesive, an acrylic coat layer agent containing an acrylic polymer whose monomer components are (meth)acrylic acid ester and (meth)acrylic acid can be preferably used as the coat layer agent. Alternatively, when the rust-proof layer 14b is a metal, a coat layer agent having a polar group, such as a carboxyl group, can be preferably used as the coat layer agent. As stated above, acrylic coat layer agents are preferred as the coat layer agent, and among them, an acrylic coat layer agent having a polar group such as a carboxyl group (hereinafter, appropriately referred to as a “polar group-containing acrylic coat layer agent”) is more preferred, in terms of the anchoring property of the coat layer for the rust-proof layer 14b and the pressure-sensitive adhesive layer 30 and further durability. As such a polar group-containing acrylic coat layer agent, an acrylic coat layer agent containing, for example, a large amount of (meth)acrylic acid (acid component) as the monomer component of an acrylic polymer can be preferably used.

As the above (meth)acrylic acid ester, (meth)acrylic acid alkyl esters, and among them, (meth)acrylic acid alkyl ester having 4 to 14 carbon atoms in an alkyl group site (hereinafter, appropriately referred to as “(meth)acrylic acid C₄₋₁₄ alkyl ester”) can be preferably used. Examples of the (meth)acrylic acid C₄₋₁₄ alkyl ester include, for example: (meth)acrylic acid butyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid heptyl, (meth)acrylic acid 2-ethylhexyl, (meth)acrylic acid octyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, (meth)acrylic acid lauryl, (meth)acrylic acid myristyl, (meth)acrylic acid isomyristyl, etc. These (meth)acrylic acid C₄₋₁₄ alkyl esters can be used alone or in combination of two or more of them.

In the acrylic coat layer agent, the ratio of (meth)acrylic acid ester to (meth)acrylic acid, which are monomer components, is not particularly limited, but can be appropriately set in accordance with the material of which the rust-proof layer 14b is composed and the type of the pressure-sensitive adhesive of which the pressure-sensitive adhesive layer 30 is composed, etc., as stated above. In order to enhance the anchoring property of the coat layer with respect to a metal, an acrylic coat layer agent containing (meth)acrylic acid as a monomer component of an acrylic polymer is preferred among acrylic coat layer agents, as stated above. In the acrylic coat layer agent containing a polymer whose monomer component is (meth)acrylic acid, the ratio of the (meth)acrylic acid as a monomer component is preferably 20% by mass or more, and more preferably 30% by mass or more, based on the total mass of the monomer components. When the ratio of the (meth)acrylic acid as a monomer component is 20% by mass or more based on the total mass of the monomer components in an acrylic polymer of which the acrylic coat layer agent is composed, the anchoring property of the coat layer with respect to a metal can be enhanced more surely, and as a result of that, the effect of enhancing the adhesiveness between the rust-proof layer 14b and the pressure-sensitive adhesive layer 30 can be enhanced more surely.

As the acrylic coat layer agent containing a polymer whose monomer component is (meth)acrylic acid, an acrylic coat layer agent containing a polymer whose monomer components are both (meth)acrylic acid in an amount of 20% by mass or more, for example, within a range of 20 to 100% by mass, and preferably within a range of 30 to 80% by mass, and (meth)acrylic acid ester in an amount of 80% by mass or less, for example, within a range of 0 to 80% by mass, and preferably within a range of 20 to 70% by mass, based on the total mass of the monomer components, can be preferably used.

In the acrylic polymer of which the acrylic coat layer agent is composed, a monomer component (copolymerizable monomer component) that can be polymerized with the (meth)acrylic acid ester and (meth)acrylic acid may be used. Examples of such a copolymerizable monomer component include, for example: copolymerizable monomers containing a carboxyl group, such as crotonic acid, itaconic acid, maleic acid, maleic anhydride, and fumaric acid (copolymerizable monomers containing a carboxyl group other than acrylic acid or methacrylic acid); copolymerizable monomers containing a hydroxyl group, such as 2-hydroxyethyl(meth)acrylate, 3-hydroxypropyl(meth)acrylate, 4-hydroxy butyl(meth)acrylate, 6-hydroxy hexyl(meth)acrylate; copolymerizable monomers containing an epoxy group, such as glycidyl(meth)acrylate; copolymerizable monomers containing an amino group, such as N,N-dimethylaminoethyl(meth)acrylic acid alkyl ester; copolymerizable monomers containing a cyano group, such as (meth)acrylonitrile; copolymerizable monomers containing an amide group, such as (meth)acrylamide and N,N-dimethyl(meth)acrylamide; and copolymerizable monomers containing various functional groups (in particular, a polar group), such as vinyl esters including vinyl acetate, as well as styrene monomers, such as styrene; and α-olefin monomers, such as ethylene and propylene.

A coat layer agent can be prepared by a publicly known method. For example, an acrylic coat layer agent can be prepared as follows: an acrylic polymer is first obtained by polymerizing, with a publicly-known polymerization method, such as a solution polymerization method or an emulsion polymerization method, monomer components, such as (meth)acrylic acid ester and (meth)acrylic acid, and if necessary, a monomer component that can be polymerized with these monomer components, and various additives; and various additives are further added, and concentration control or emulsification is performed, if necessary. A coat layer can be formed on the surface of the rust-proof layer 14b or the pressure-sensitive adhesive layer 30 by applying the coat layer agent. The thickness of the coat layer is not particularly limited, but, for example, within a range of approximately 0.5 to 30 μm, preferably within a range of approximately 0.5 to 10 μm, and more preferably within a range of approximately 1 to 5 μm. If the thickness thereof is too small, the effect of enhancing the adhesiveness between the rust-proof layer 14b and the pressure-sensitive adhesive layer 30 is decreased, and if the thickness thereof is too large, the thickness of the pressure-sensitive adhesive label 1 for HDD becomes large.

As described above, the pressure-sensitive adhesive label 1 for HDD according to the embodiment comprises: the substrate layer 12 composed of a metallic foil; the rust-proof layers 14a and 14b covering the major surfaces of the substrate layer 12; the information display layer 20, on the surface of which printing can be performed, provided on one of the major surfaces of the laminated body 10 made of the substrate layer 12 and the rust-proof layers 14a and 14b; and the pressure-sensitive adhesive layer 30 provided on the other major surface of the laminated body 10. Accordingly, the pressure-sensitive adhesive label 1 for HDD according to the embodiment can satisfy both an information display function as a label and a function of reducing the sound generated when a hard disk drive is driven, by being pasted to the external surface of the case of the hard disk drive. Further, because the pressure-sensitive adhesive label 1 for HDD comprises the rust-proof layers 14a and 14b covering the major surfaces of the substrate layer 12, it can be prevented that the metallic foil of which the substrate layer 12 is composed may be rusted due to the progression of the oxidation thereof. Accordingly, the durability of the pressure-sensitive adhesive label 1 for HDD can be enhanced, and it can be prevented that the information display function may be decreased by the rust of the metallic foil.

### EXAMPLES

Hereinafter, the present invention will be described in detail based on examples, but the invention should not be limited at all by these examples.

### Example 1

### (Formation of Laminated Body 10 and Information Display Layer 20)

An iron foil having a thickness of approximately 53 μm was prepared as the substrate layer 12, and zinc plated layers were formed, with a hot dip plating method, on the surfaces of the iron foil as the rust-proof layers 14a and 14b. The amount of the zinc attached to the iron foil was set to be 5 g/cm². The thickness of the zinc plated layer was approximately 0.7 μm. A white polyethylene terephthalate film layer having a thickness of approximately 20 μm was laminated, with a lamination method using dry lamination adhesion, on one of the major surfaces of the obtained laminated body made of the iron foil and the zinc plated layers. This white polyethylene terephthalate film layer corresponds to the information display layer 20.

### (Preparation of Pressure-Sensitive Adhesive)

Ten parts by mass of acrylic acid, 90 parts by mass of isononyl acrylate, and 0.1 parts by mass of a photo-initiator (Product Name: “IRGACURE 184 (made by BASF)”) were placed into a three-neck flask, and the inside of the reaction system was replaced with nitrogen by stirring them for 1 hour while introducing nitrogen. Thereafter, ultraviolet (UV) light having an energy of approximately 150 mJ was emitted to the mixture with a UV lamp to obtain a prepolymer by performing a reaction in which a polymerization rate was approximately 10%. Trimethylolpropane triacrylate (TMPTA) in an amount of 0.2 parts by mass in terms of solid content was further added as an internal cross-linking agent, based on 100 parts by mass of the prepolymer, to obtain a pressure-sensitive adhesive by stirring them.

### (Formation of Pressure-Sensitive Adhesive Layer 30 and Covering by Release Liner 40)

The prepared pressure-sensitive adhesive was applied to one of the major surfaces of the laminated body, on the other major surface of which the white polyethylene terephthalate film layer had been laminated, so that the thickness of the pressure-sensitive adhesive was approximately 25 μm. Subsequently, the surface of the pressure-sensitive adhesive was shielded from the air layer by pasting the surface of a polyethylene terephthalate film (release liner A) near to a silicone release agent layer that has been formed on the surface of the polyethylene terephthalate film, to the surface of the applied pressure-sensitive adhesive. UV light having an energy of approximately 2000 mJ was then emitted from the release liner A side with a UV lamp to react the components contained in the pressure-sensitive adhesive with each other, thereby obtaining the laminated body, on the one of the major surfaces of which the pressure-sensitive adhesive layer 30 had been formed. After the release liner A was released from the laminated body, the laminated body was dried in an oven at approximately 130° C. for approximately 1 minute to remove volatile components from the pressure-sensitive adhesive layer 30. A release liner B made only of a low density polyethylene film was again pasted to the surface of the laminated body to produce the pressure-sensitive adhesive label 1 for HDD according to Example 1.

### Example 2

Chromate films were formed on the surfaces of zinc plated layers by subjecting the laminated body made of the iron foil and the zinc plated layer to a chromate treatment. The pressure-sensitive adhesive label 1 for HDD was produced in the same way as Example 1 other than that. The thickness of the chromate film was approximately 0.005 μm.

### Example 3

### (Preparation of Coat Layer Agent and Formation of Coat Layer)

A coat layer agent was obtained by adding an isocyanate cross-linking agent (Product Name: “CORONATE L” made by Nippon Polyurethane Industry Co., Ltd.) in an amount of 100 parts by mass in terms of solid content to a polyester resin (Product Name: “VYLON 103” made by Toyobo Co., Ltd.) in an amount of 100 parts by mass in terms of solid content. Coat layers were formed on the surfaces of the laminated body made of the iron foil and the zinc plated layer by applying the coat layer agent with a dip coat method. The thickness of the coat layer was 0.5 μm. The pressure-sensitive adhesive label 1 for HDD was produced in the same was as Example 1 other than that.

### Comparative Example 1

A pressure-sensitive adhesive label for HDD was produced in the same way as Example 1, except that zinc plated layers were not formed on the iron foil.

Accordingly, the structures of the pressure-sensitive adhesive labels for HDD according to Examples 1 to 3 and Comparative Example 1 are as follows.

Example 1: information display layer/zinc plated layer/iron foil/zinc plated layer/pressure-sensitive adhesive layer

Example 2: information display layer/chromate film/zinc plated layer/iron foil/zinc plated layer/chromate film/pressure-sensitive adhesive layer

Example 3: information display layer/zinc plated layer/iron foil/zinc plated layer/coat layer/pressure-sensitive adhesive layer

Comparative Example 1: information display layer/iron foil/pressure-sensitive adhesive layer

### (Evaluation of Rust-Proof Property)

After each of the pressure-sensitive adhesive labels according to Examples 1 to 3 and Comparative Example 1 was left in the atmosphere having a temperature of 85° C. and a humidity of 85% for 200 hours, an occurrence of rust was visually confirmed from the information display layer side. A result of the evaluation of the rust-proof properties was indicated by “A” when no rust was confirmed, or by “B” when rust was confirmed. The results are shown in Table 1.

### (Evaluation of Damping Property)

Each of the pressure-sensitive adhesive labels according to Examples 1 to 3 and Comparative Example 1 was pasted to a portion in the external surface of the top cover of a commercially available 2.5″ hard disk drive, the portion occupying 65%, in terms of surface area ratio, of the external surface. The hard disk drive was installed on a highly sound insulating rubber foam (thickness: 20 mm) on a test stand that has been installed in an anechoic chamber. The hard disk drive was installed such that the surface thereof to which the pressure-sensitive adhesive label had been pasted was turned upward. The highly sound insulating rubber foam was used in order to prevent the solid-borne sound of the test stand, occurring due to the propagation of vibrations of the hard disk drive, and to shield the noise from the bottom surface of the hard disk drive. After being driven by turning on the power source of the hard disk drive, the hard disk drive was left until the noise level generated when driven (sound generated when driven) was stabilized. Thereafter, a noise level was measured by a free-field microphone installed at a position approximately 300 mm higher above the central portion. Each of the measured values was subjected to an averaging treatment for 20 seconds by using the A-weighting as frequency weighting to be represented by an overall value ranging from 20 to 20000 Hz as a frequency range. The noise level of each of the pressure-sensitive adhesive labels according to Examples 1 to 3 and Comparative Example 1 was measured before and after the pressure-sensitive adhesive label was pasted. As a result of that, the noise level was approximately 27 dB (A) after the label was pasted, while that was approximately 31 dB (A) before the label was pasted.

### (Evaluation of Preventing Property for Adhesive Deposit)

A test piece was made by cutting each of the pressure-sensitive adhesive labels according to Examples 1 to 3 and Comparative Example 1 into a 20 mm width. The test piece was pasted to a stainless steel plate, used as an adherend, by reciprocating a rubber roller (2 kg) once. After the pasting, the stainless steel plate was aged at room temperature for 30 minutes, and further was left in an oven at 60° C. for 2 hours. After the stainless steel plate to which the test piece had been pasted was taken out from the oven and cooled in air for 1 hour, the test piece was peeled off from the stainless steel plate at room temperature (23° C.) and under the conditions in which a release angle was 180° and a release speed was 300 mm/min. In the stainless steel plate from which the test piece had been peeled off, the ratio (%) of the area of a portion where adhesive deposit was generated to the area to which the test piece had been pasted was measured. A result of the evaluation of the preventing property for adhesive deposit was indicated by “A” when the ratio was less than 30%, or by “B” when the ratio was 30% or more. The results are shown in Table 1.

TABLE 1

| | EXAM- | EXAM- | EXAM- | COMPARATIVE |
|---|---|---|---|---|
| | PLE 1 | PLE 2 | PLE 3 | EXAMPLE 1 |
| RUST-PROOF | A | A | A | B |
| PROPERTY | | | | |
| PREVENTING | B | B | A | B |
| PROPERTY | | | | |
| FOR ADHESIVE | | | | |
| DEPOSIT | | | | |

As shown in Table 1, the rust-proof property in Comparative Example 1 was no good (B). On the other hand, those in Examples 1 to 3 were good (A). It has been confirmed from these results that the rust-proof layer can effectively suppress the generation of rust. Accordingly, it has been learned that, by providing the rust-proof layer, the durability of the pressure-sensitive adhesive label for HDD can be enhanced and a decrease in the information display function can be reduced. Further, the preventing property for adhesive deposit can also be good (A) in Example 3. It has been confirmed from this result that the coat layer can effectively enhance the adhesiveness between the rust-proof layer and the pressure-sensitive adhesive layer. Furthermore, a difference in the damping property has not been observed between Examples 1 to 3 and Comparative Example 1. It has been confirmed from this result that, even if the rust-proof layer is provided, the generated sound reducing effect of the pressure-sensitive adhesive label for HDD can be satisfactorily maintained.

The aforementioned embodiments will be summarized below.

(Item 1) A pressure-sensitive adhesive label for hard disk drive that has an information display function and can reduce the sound generated when a hard disk drive is driven by being pasted to the external surface of the case of the hard disk drive, the pressure-sensitive adhesive label for hard disk drive comprising: a substrate layer composed of a metallic foil; a rust-proof layer covering at least one of the major surfaces of the substrate layer; an information display layer, on the surface of which printing can be performed, provided on one of the major surfaces of a laminated body made of the substrate layer and the rust-proof layer; and a pressure-sensitive adhesive layer provided on the other major surface of the laminated body.

(Item 2) The pressure-sensitive adhesive label for hard disk drive according to item 1, wherein the rust-proof layer is made of a material that is more resistant to rust than the metallic foil.

(Item 3) The pressure-sensitive adhesive label for hard disk drive according to item 1 or item 2, wherein the rust-proof layer is a plated layer or a chemical conversion treatment layer provided on the surface of the metallic foil.

(Item 4) The pressure-sensitive adhesive label for hard disk drive according to any one of items 1 to 3, wherein the metallic foil is an iron foil, and wherein the rust-proof layer is made of a metal selected from the group consisting of zinc, tin, nickel, and chromium.

(Item 5) The pressure-sensitive adhesive label for hard disk drive according to item. 4 further comprising a chromate film provided on the major surface of the rust-proof layer, opposite to the substrate layer.

(Item 6) The pressure-sensitive adhesive label for hard disk drive according to any one of items 1 to 5, wherein the rust-proof layer is provided at least between the substrate layer and the pressure-sensitive adhesive layer, and wherein the pressure-sensitive adhesive label for hard disk drive further comprises a coat layer that is provided between the rust-proof layer and the pressure-sensitive adhesive layer to enhance the adhesiveness between the two.

(Item 7) The pressure-sensitive adhesive label for hard disk drive according to any one items 1 to 6, wherein the pressure-sensitive adhesive layer contains an acrylic polymer.

(Item 8) A method of manufacturing a pressure-sensitive adhesive label for hard disk drive that has an information display function and can reduce the sound generated when a hard disk drive is driven by being pasted to the external surface of the case of the hard disk drive, the method comprising: forming a laminated body made of a substrate layer and a plated layer by subjecting the substrate layer composed of a metallic foil to plate processing; forming, on one of the major surfaces of the laminated body, an information display layer, on the surface of which printing can be performed; and forming a pressure-sensitive adhesive layer on the other major surface of the laminated body.

What is claimed is:

1. A pressure-sensitive adhesive label for hard disk drive that has an information display function and can reduce the sound generated when a hard disk drive is driven by being pasted to the external surface of the case of the hard disk drive, the pressure-sensitive adhesive label for hard disk drive comprising:
a substrate layer composed of a metallic foil;
a rust-proof layer covering at least one of the major surfaces of the substrate layer;
an information display layer, on the surface of which printing can be performed, provided on one of the major surfaces of a laminated body made of the substrate layer and the rust-proof layer; and
a pressure-sensitive adhesive layer provided on the other major surface of the laminated body.

2. The pressure-sensitive adhesive label for hard disk drive according to claim 1, wherein
the rust-proof layer is made of a material that is more resistant to rust than the metallic foil.

3. The pressure-sensitive adhesive label for hard disk drive according to claim 1, wherein
the rust-proof layer is a plated layer or a chemical conversion treatment layer provided on the surface of the metallic foil.

4. The pressure-sensitive adhesive label for hard disk drive according to claim 1, wherein
the metallic foil is an iron foil, and wherein
the rust-proof layer is made of a metal selected from the group consisting of zinc, tin, nickel, and chromium.

5. The pressure-sensitive adhesive label for hard disk drive according to claim 4 further comprising:
a chromate film provided on the major surface of the rust-proof layer, opposite to the substrate layer.

6. The pressure-sensitive adhesive label for hard disk drive according to claim 1, wherein
the rust-proof layer is provided at least between the substrate layer and the pressure-sensitive adhesive layer, and wherein
the pressure-sensitive adhesive label for hard disk drive further comprises a coat layer that is provided between the rust-proof layer and the pressure-sensitive adhesive layer to enhance the adhesiveness between the two.

7. The pressure-sensitive adhesive label for hard disk drive according to claim 1, wherein
the pressure-sensitive adhesive layer contains an acrylic polymer.

8. A method of manufacturing a pressure-sensitive adhesive label for hard disk drive that has an information display function and can reduce the sound generated when a hard disk drive is driven by being pasted to the external surface of the case of the hard disk drive, the method comprising:
forming a laminated body made of a substrate layer and a plated layer by subjecting the substrate layer composed of a metallic foil to plate processing;
forming, on one of the major surfaces of the laminated body, an information display layer, on the surface of which printing can be performed; and
forming a pressure-sensitive adhesive layer on the other major surface of the laminated body.

9. The pressure-sensitive adhesive label for hard disk drive according to claim 2, wherein
the rust-proof layer is a plated layer or a chemical conversion treatment layer provided on the surface of the metallic foil.

10. The pressure-sensitive adhesive label for hard disk drive according to claim 2, wherein
the metallic foil is an iron foil, and wherein
the rust-proof layer is made of a metal selected from the group consisting of zinc, tin, nickel, and chromium.

11. The pressure-sensitive adhesive label for hard disk drive according to claim 3, wherein
the metallic foil is an iron foil, and wherein
the rust-proof layer is made of a metal selected from the group consisting of zinc, tin, nickel, and chromium.

12. The pressure-sensitive adhesive label for hard disk drive according to claim 9, wherein
the metallic foil is an iron foil, and wherein
the rust-proof layer is made of a metal selected from the group consisting of zinc, tin, nickel, and chromium.

13. The pressure-sensitive adhesive label for hard disk drive according to claim 10 further comprising:
a chromate film provided on the major surface of the rust-proof layer, opposite to the substrate layer.

14. The pressure-sensitive adhesive label for hard disk drive according to claim 11 further comprising:
a chromate film provided on the major surface of the rust-proof layer, opposite to the substrate layer.

15. The pressure-sensitive adhesive label for hard disk drive according to claim 12 further comprising:
a chromate film provided on the major surface of the rust-proof layer, opposite to the substrate layer.

16. The pressure-sensitive adhesive label for hard disk drive according to claim 2, wherein
the rust-proof layer is provided at least between the substrate layer and the pressure-sensitive adhesive layer, and wherein
the pressure-sensitive adhesive label for hard disk drive further comprises a coat layer that is provided between the rust-proof layer and the pressure-sensitive adhesive layer to enhance the adhesiveness between the two.

17. The pressure-sensitive adhesive label for hard disk drive according to claim 3, wherein
the rust-proof layer is provided at least between the substrate layer and the pressure-sensitive adhesive layer, and wherein
the pressure-sensitive adhesive label for hard disk drive further comprises a coat layer that is provided between the rust-proof layer and the pressure-sensitive adhesive layer to enhance the adhesiveness between the two.

18. The pressure-sensitive adhesive label for hard disk drive according to claim 4, wherein
the rust-proof layer is provided at least between the substrate layer and the pressure-sensitive adhesive layer, and wherein
the pressure-sensitive adhesive label for hard disk drive further comprises a coat layer that is provided between the rust-proof layer and the pressure-sensitive adhesive layer to enhance the adhesiveness between the two.

19. The pressure-sensitive adhesive label for hard disk drive according to claim 5, wherein
the rust-proof layer is provided at least between the substrate layer and the pressure-sensitive adhesive layer, and wherein
the pressure-sensitive adhesive label for hard disk drive further comprises a coat layer that is provided between the rust-proof layer and the pressure-sensitive adhesive layer to enhance the adhesiveness between the two.

20. The pressure-sensitive adhesive label for hard disk drive according to claim 9, wherein
the rust-proof layer is provided at least between the substrate layer and the pressure-sensitive adhesive layer, and wherein
the pressure-sensitive adhesive label for hard disk drive further comprises a coat layer that is provided between the rust-proof layer and the pressure-sensitive adhesive layer to enhance the adhesiveness between the two.
